(19) United States
(12) Patent Application Publication
(10) Pub. No.: US 2011/0093412 A1
(43) Pub. Date: Apr. 21, 2011

(54) SYSTEM AND METHOD FOR PROMOTING CHARITABLE CONTRIBUTIONS

(76) Inventors: Edward Kaplan, Boca Raton, FL (US); Marilyn L. Soffer, Boca Raton, FL (US)

(21) Appl. No.: 12/820,465

(22) Filed: Jun. 22, 2010

Related U.S. Application Data
(60) Provisional application No. 61/219,171, filed on Jun. 22, 2009.

(51) Int. Cl. G06Q 90/00

(52) U.S. Cl. 705/500

(57) ABSTRACT

An organization TGS is formed to be dedicated, for example, to raise funds for a particular charitable, religious or health cause or to a predefined group of causes, members of TGS dedicating themselves to contributing to TGS on an ongoing basis, for example, annually. Upon making an initial contribution, a member of TGS receives a token, a unique and attractive piece of jewelry, for example a brooch, pendant, or lapel pin. The jewelry piece is constructed to be enhanced, for example, by the addition of a jewelry stone every time a periodic contribution is made.

This application claims the benefit of U.S. Provisional Patent Application No. 61/219,171 filed Jun. 22, 2009.

### BACKGROUND OF THE INVENTION

This patent application relates generally to business methods and systems and, more particularly, concerns a system and method for promoting charitable contributions.

Charitable contribution has always been encouraged in our society, based upon cultural and religious principles. The present invention adds an element of prestige and glamour to charitable giving, encouraging members of the public to contribute more to charity.

In accordance with one aspect of the present invention, an organization is formed, hereafter referred to as “The Giving Society” (TGS). TGS is dedicated to dedicated, for example, to raising funds for a particular charitable, religious or health cause or to a predefined group of causes, members of TGS dedicating themselves to contributing to TGS on an ongoing basis, for example, annually. Upon making an initial contribution, a member of TGS receives a token, a unique and attractive piece of jewelry, for example a brooch, pendant, or lapel pin. The jewelry piece is constructed to be enhanced, for example, by the addition of a jewelry stone every time a periodic contribution is made.

Hence, the jewelry piece is not only a prestigious indication of membership in TGS, but is also representative of a member's generosity. Members are rewarded for their generosity and encouraged to make future contributions owing to the availability of enhancements.

### BRIEF DESCRIPTION OF THE DRAWING

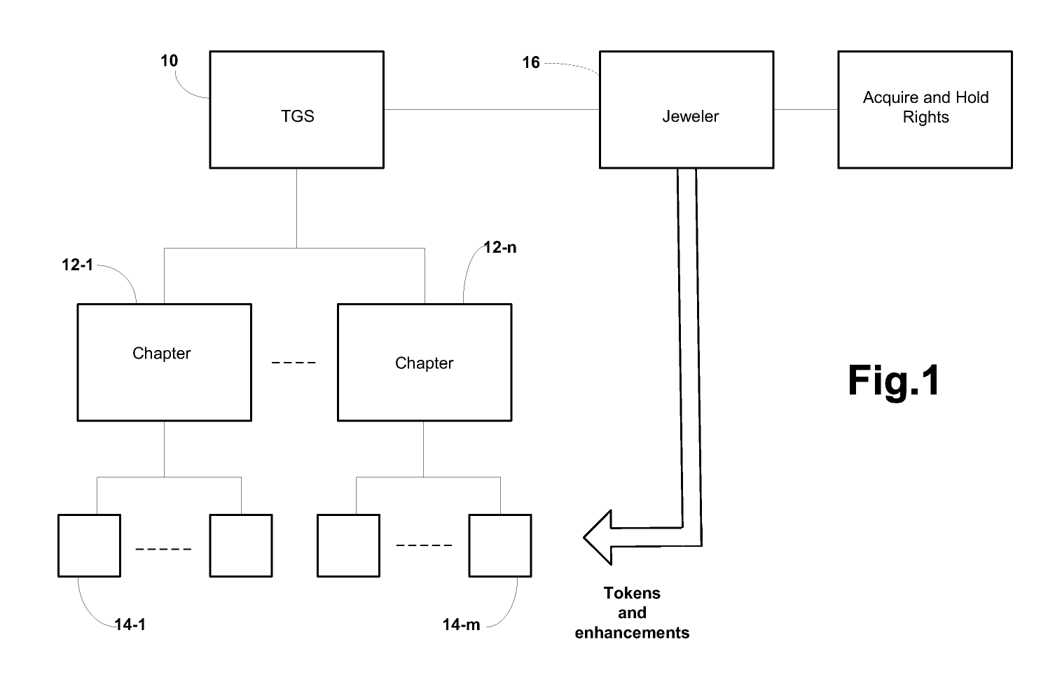

The foregoing brief description and further objects, features and advantages of the present invention will be understood more completely from the following detailed description of a presently preferred, but nonetheless illustrative, embodiment in accordance with the present invention, with reference being added to the accompanying drawing, in which FIG. 1, the only FIGURE, is a functional block diagram illustrating the business method.

### DETAILED DESCRIPTION

The Giving Society (TGS) 10 is an organization, the members of which are dedicated to raising funds for a charitable or religious organization XYZ and has developed an association in the eyes of the public with XYZ. Members of TGS make an initial contribution to XYZ and are committed to further periodic contributions to XYZ. The members wear a jewelry token as a kind of badge. Tokens are awarded after an initial contribution and are enhanced after future contributions, as by having a jewelry stone added or by being upgraded to a token with a different appearance. For example, a token made of bronze could be enhanced to one made of silver, or silver token could be enhanced to one made of gold. It is contemplated that members could receive enhanced tokens initially based upon the amount of the initial contribution.

Referring to FIG. 1, which is a functional block diagram illustrating a preferred method in accordance with the present invention, it is contemplated that TGS would be organized in chapters 12-1 . . . 12-n, which could be geographically based. TGS, itself, could be dedicated to supporting an international, national or regional religious organization, or a non-religious organization, such as the International Red Cross or the American Cancer Society or a local hospital. The local chapters of TGS might then be associated with or dedicated to local chapters of the charitable organization. Members 14-1 . . . 14-m of TGS are members of respective local chapters 12-1 . . . 12-n.

Jewelry piece tokens are provided by a sole source, hereafter referred to as the JEWELER 16, which is responsible for the supply or manufacture of jewelry pieces and securing, maintenance and holding or ownership of all commercial and legal rights (e.g. patents, trademarks and copyrights) to ensure the availability and uniqueness of jewelry pieces. JEWELER is compensated for its services by receiving a fee from TGS for each jewelry piece, the fee being paid out of contributions made by TGS members. JEWELER 16, in turn provides tokens and enhancements thereof to members 14-1 . . . 14-m. For example, the tokens could be sent to the local chapter and presented to members during a ceremony at an installation/enhancement meeting.

The jewelry piece token is not only a prestigious indication of membership in TGS, but is also representative of a member's generosity. Members are rewarded for their generosity and encouraged to make future contributions owing to the availability of enhancements, the enhanced tokens becoming status symbols.

As holder of the commercial and legal rights, JEWELER is empowered to protect the uniqueness of tokens and simultaneously ensured of receiving compensation for his best efforts.

Although a preferred embodiment of the invention has been disclosed for illustrative purposes, those skilled in the will appreciate that many additions, modifications and substitutions are possible without departing from the scope and spirit of the invention as disclosed.

What is claimed:

1. A system for raising funds for XYZ, a charitable or religious organization, comprising:
an organization TGS dedicated to raising funds for XYZ, TGS having a plurality of members, the members of TGS wearing a token, constructed to be enhanced, which toke is indicative of membership;
a source organization constructed to acquire tokens and enhancements which is the sole source of tokens and enhancements, the source organization being the holder of commercial and legal rights in tokens and enhancements, the source organization providing tokens and enhancements for members;
the tokens being constructed to be enhanced so as to be different in appearance, enhancements being made based on one of the amount of a member's contribution to XYZ, the number of contributions to XYZ, and a subsequent contribution to XYZ after an initial contribution.

2. The system of claim 1 wherein the legal right include one of patents, trademarks and copyrights.

3. The system of claim 1 wherein an enhancement includes one of the addition of a stone to the token and the token being made of a different material or having the appearance of being made of a different material.

4. A method for raising funds for XYZ, a charitable or religious organization, comprising:
providing an organization TGS dedicated to raising funds for XYZ, TGS having a plurality of members, the members of TGS wearing a token, constructed to be enhanced, which token is indicative of membership;
providing a source organization constructed to acquire tokens and enhancements which is the sole source of tokens and enhancements, the source organization being the holder of commercial and legal rights in tokens and enhancements, the source organization providing tokens and enhancements for members;
the tokens being constructed to be enhanced so as to be different in appearance, enhancements being made based on one of the amount of a member's contribution to XYZ, the number of contributions to XYZ, and a subsequent contribution to XYZ after an initial contribution.

5. The method of claim 4 wherein the legal rights include one of patents, trademarks and copyrights.

6. The organization of claim 4 wherein an enhancement includes one of the addition of a stone to the token and the token being made of a different material or having the appearance of being made of a different material.
